(19) United States
(12) Patent Application Publication
(10) Pub. No.: US 2017/0315817 A1
(43) Pub. Date: Nov. 2, 2017

(54) POWER LIFEGUARD SYSTEM

(71) Applicant: Engineered Data Products, LLC, Broomfield, CO (US)

(72) Inventor: Michael Anton PRITCHARD, Erie, CO (US)

(21) Appl. No.: 15/498,627

(22) Filed: Apr. 27, 2017

Related U.S. Application Data
(60) Provisional application No. 62/328,236, filed on Apr. 27, 2016.

(51) Int. Cl. G06F 9/44; G06F 1/32; G06F 11/14

(52) U.S. Cl. CPC G06F 9/4401; G06F 11/1417; G06F 1/3212; G06F 1/3287; G06F 1/3296

(57) ABSTRACT

The power lifeguard system invention is an intelligent system for small-board computer equipment that promotes equipment uptime by providing power and battery back up. The invention monitors battery life and health and ensures proper computer equipment shutdown and reboot processes. The power lifeguard system is compatible with many single board computers (SBCs) using minimal packaging space and optimizing energy consumption of the computer equipment.

### TECHNICAL FIELD

The invention relates to power systems and uninterruptible power supplies. More particularly, the invention relates to systems and techniques of managing uptime and power for SBCs (Single-Board Computers).

### BACKGROUND

Uninterruptible power supplies (UPS) and systems provide back-up power to computer systems and other critical systems, where a loss of line power can result in an interruption of programs and/or loss of valuable data. Uninterruptible power supplies can also provide a power conditioning function to prevent transient spikes, low-voltage conditions, and/or distorted power waveforms from disturbing operation of the computer or other critical system supplied with power via the UPS. Often, UPS systems include a battery connected through an inverter to the AC output line of the system at the same frequency and with substantially the same waveform as the normal AC power input to the system. A UPS with battery back up can condition power, neutralize surges, and provide backup power when utility power is unreliable or as a stop gap to provide power while a generator or other transfer switch clicks on. A UPS helps improve uptime of computer systems.

Single board computers (SBCs) provide an expanding new technology in computer systems. Single-board computers (SBCs) afford a complete computer built on a single circuit board, with microprocessor(s), memory, input/output (I/O) and other features required of a functional computer. By putting all the functions on a single board, a smaller overall computer system can be obtained. Machine and process control systems often use SBCs. SBCs often range in price from about $35 to a several hundred dollars. Millions of these small computers have been sold and used in a variety of applications including home automation, security, displays, kiosks, weather tracking, sensor tracking, remote systems integration, and other targeted systems.

SBCs can be about the size of a credit card and perform a set of targeted functions. Many have video resolution in the 1080p range, GPIO ports (i.e., general-purpose input/output ports), static RAM, and GHz processors.

Uninterrupted power supplies (UPS) provide emergency power to a load when an input power source fails. If power drops, a UPS provides enough power to the computer so it can shut down without corruption. In some cases, the UPS will send a shutdown command to the computer via a serial (USB) connection.

It is difficult to manage uptime and restart remote systems, regardless of power outages or hardware/software failures. Phone calls to remote facilities often result in frustration and loss of credibility. Operators are often unfamiliar with restart procedures and are frustrated with the need for remote technical support. Additionally, current UPSs often involve significant upfront, installation, maintenance, and disposal costs.

### SUMMARY

The systems and methods of the invention provide a UPS with improved functionality to ensure computers, and in particular SBCs, remain operational in the event of a power outage or other power anomaly. In many applications, such as display systems, for example, space for computers behind the display is limited. There is no room for a battery backup, and single board computers are often used to drive video content. For example, many SBCs such as Raspberry Pi and BeagleBone systems can be used to power interactive displays, RFID readers, and the like. The single board computers use less power and less space. For example, some SBCs use from 3-12 watts of power while PCs often use 75-100 watts of power. Other single board computers (SBCs) operate on 5 volts and about 2 amps. The invention provides a battery and power management system in a small footprint and enclosure to provide power, monitor the health of batteries, and monitor the health of remote single board computer systems.

The invention monitors power-flow and communicates power outages and anomalies to single board computer systems to minimize disruptions. Even when power is cut off, the invention provides an automatic restoration process to the single board computer systems to minimize operator frustration when restoring power and monitoring system health.

The invention uses GPIO port signals (general-purpose input/output ports) on single board computers to communicate with the power system and other sensors. If power drops, the system continues to provide power through a battery and capacitive power back up and warns the computer that power is off so the computer can save critical data. If power is restored within a specified time, the system continues as though nothing happened, but if power remains off for a specified amount of time, the system of the invention warns the computer (e.g., PC, SBC, etc.) that power will be shut off. After a specified amount of time, the system turns off power to the computer. After main power is restored, the system turns power to the computer back on, which will auto-boot the computer.

The computer (PC, SBC, and the like) provides a heartbeat signal back to the system as a monitor to ensure the computer (PC, SBC, and the like) is responding. If the computer turns off or becomes unresponsive, the system will power-cycle the computer to force a reboot.

The timespan settings (predetermined times) for warning that power is off and for determining a lack of power to effect a shutdown can be set via dip-switches, touch screen, web service interface, and other hardware and/or software selection devices.

Some SBCs are sensitive to input even when they are powered off. The system of the invention includes logic and processing modules to ensure signals are not received when the SBC is off. Additionally, some example systems of the invention include a remote boot function that adds additional capabilities to force a reboot from a remote location. When network access is available, the system with a remote boot controller calls a web service, obtains commands, and reboots the SBC.

The invention provides battery backup, monitors battery charge/health, tracks the health of SBCs and initiates a reboot if the SBC health becomes unstable. The invention further provides a failsafe for proper shutdown of remote/critical SBC systems when the battery charge is low. Similarly, the invention starts up SBC systems when power is restored and the batteries are charged enough to sustain SBC operations. The invention can also accept and process remote commands to configure the power system and cleanly reboot SBCs.

The power lifeguard of the invention is a power management system. The power management system include a battery backup; and a computer controller (system) that monitors operational status of the battery back up and monitors operational status of a computer system to which the power management system is operatively connected. In some example systems of the invention, the power lifeguard system is a single printed circuit board (PCB). In some example systems of the invention, the small footprint and enclosure dimensions of the power lifeguard makes it particularly useful with single board computers (SBCs). As outlined above, some of the SBCs operate on 12 watts or less.

The power lifeguard systems of the invention identify the operational status of the computer systems, including the loss of power to the computer system and/or the loss of a communication (e.g., heartbeat) signal from the computer system to the power lifeguard, such as from an SBC, for example.

The controller (system) of the power lifeguard systems receives its status signals using GPIO ports. The computer controller system can include multiple general purpose input/output (GPIO) ports that receive a battery status signal to monitor the operational status of the battery back up and/or a heartbeat signal to monitor the operational status of the computer system to which the power management system is operatively connected. The lifeguard power management system can also include a charge controller operatively connected to the battery back up that limits the rate at which current is added to or drawn from the battery back up.

The power lifeguard systems can include a switch controlled by the computer controller that provides power to the computer system, including to SBCs. The SBCs and other computer systems can include communication code to communicate with the lifeguard power management system.

Some example lifeguard power management systems include a remote interface that initiates the turning off the uninterrupted backup source of power to the computer system via a computer network.

The invention also includes a method of managing power (including removing power) from a computer system using the lifeguard power management system. One example method of the invention includes sensing an unresponsive computer system with a computer controller system, providing an uninterrupted backup source of power to the computer system, warning the computer system of an imminent booting of the computer system, and turning off the uninterrupted backup source of power to the computer system.

Sensing an unresponsive computer system can include identifying a loss of power to the computer system and/or identifying a loss of a communication signal from the computer system to the computer controller. The method for removing power after a power outage and warning the computer system can include confirming the uninterrupted backup source of power to the computer system has dropped below a predetermined level, setting a general purpose input/output (GPIO) port to communicate with the computer system that a boot event is imminent, waiting a predetermined period of time to provide the computer system an opportunity to shut down in a controlled manner, and setting a general purpose input/output (GPIO) port to operate a switch to remove power from the computer system. Additionally, power can be removed from the computer system using a remote system connected to a computer network that sends a soft reboot signal to a remote interface via a computer network.

Similarly, the method of removing power to the computer system after loss of communication signal (including a heartbeat) and warning the computer system can include identifying a loss of a heartbeat signal from the computer system to the computer controller system. In one example system, the method of managing power to a computer system includes turning off the uninterrupted backup source of power to the computer system by setting a timer to a predetermined period of time, monitoring the heartbeat signal from the computer system at a general purpose input/output port of the computer controller system during the predetermined period of time, confirming that the loss of the heartbeat signal from the computer system at the general purpose input/output port of the computer controller system has not recovered during the predetermined period of time, setting a general purpose input/output (GPIO) port to communicate with the computer system that a boot event is imminent, waiting a predetermined period of time to provide the computer system an opportunity to shut down in a controlled manner, and setting a general purpose input/output (GPIO) port to operate a switch to remove power from the computer system.

Additionally, turning off the uninterrupted backup source of power to the computer system can include receiving a soft reboot signal from a remote interface via a computer network to operate the switch to remove power from the computer system.

The system of the invention also manages power to the computer system by restoring power to initiate a boot sequence of the computer system. A method of managing power to a computer system of claim 18, wherein Restoring power to the computer system to initiate a boot sequence of the computer system can include receiving a battery status signal at a general purpose input/output (GPIO) port of the computer controller system, determining a voltage level of the uninterrupted backup source of power to the computer system is within a predetermined voltage range based upon the received battery status signal, and setting a general purpose input/output (GPIO) port of the computer controller system to operate a switch to restore power to the computer system.

The power management systems and methods of the invention provide new capabilities not available with current systems, including computer (SBC) uptime management and restarting capabilities in a small footprint enclosure that provides installation savings and on-going support savings over other UPSs that often involve significant upfront, installation, maintenance, and disposal costs.

### BRIEF DESCRIPTION OF THE DRAWINGS

FIG. 1 shows an example system diagram incorporating a power lifeguard in accordance the invention.

FIG. 2 shows an example process flow diagram of a heartbeat circuit in accordance with a system of the invention.

FIG. 3 shows an example process flow diagram of a power delivery circuit in accordance with a system of the invention.

FIGS. 4A-4E show example illustrations of GPIO ports on the controller in a system of the invention highlighting the small footprint and package of the power lifeguard system and the controller.

FIG. 5 shows an example communication code installed on a single board computer to communicate with a power lifeguard of the invention.

FIG. 6 shows an example system diagram incorporating a power lifeguard in accordance the invention with web service access for remote commands.

### DETAILED DESCRIPTION

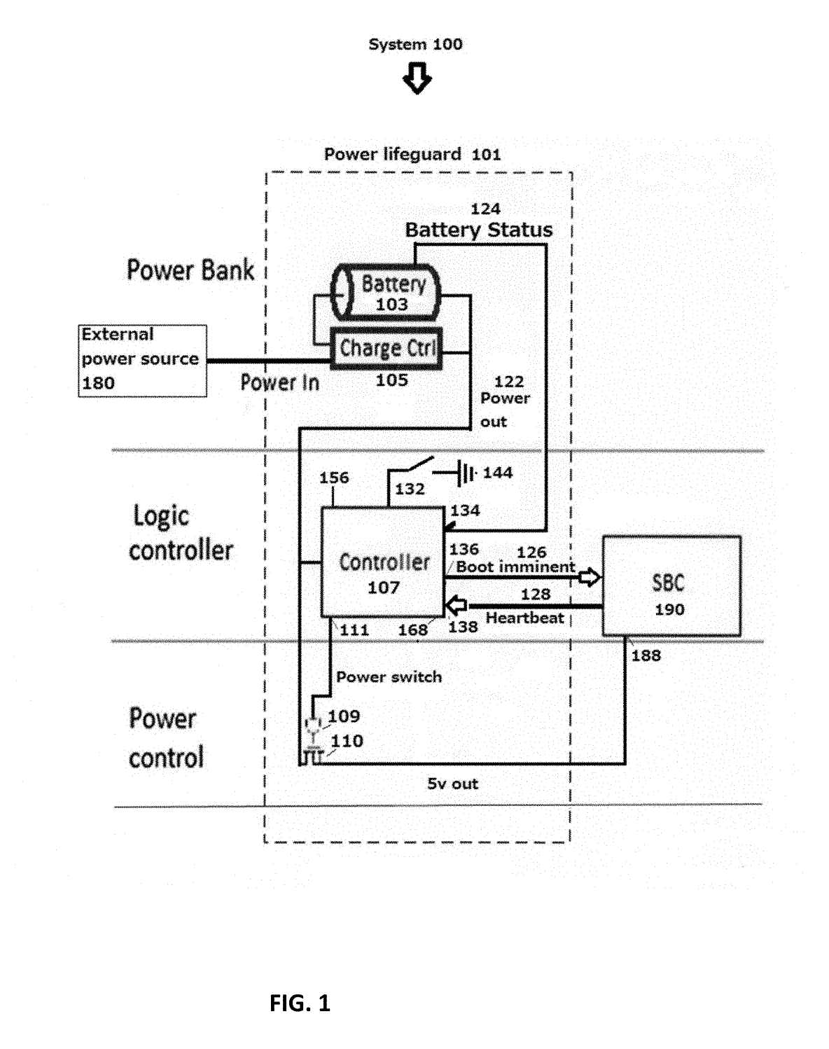

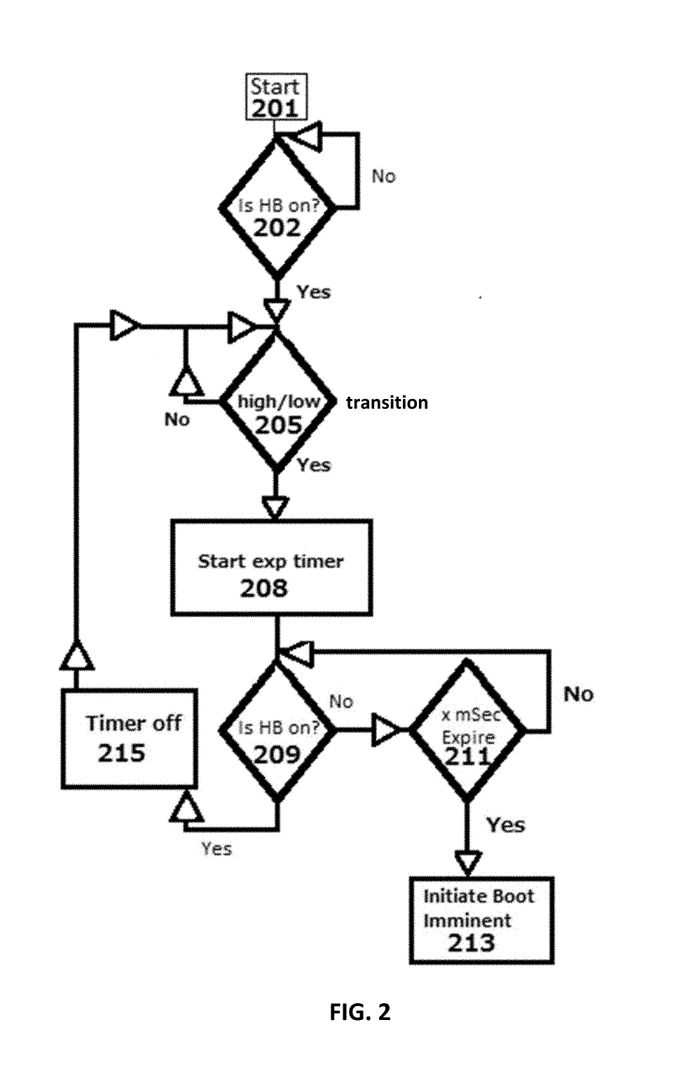

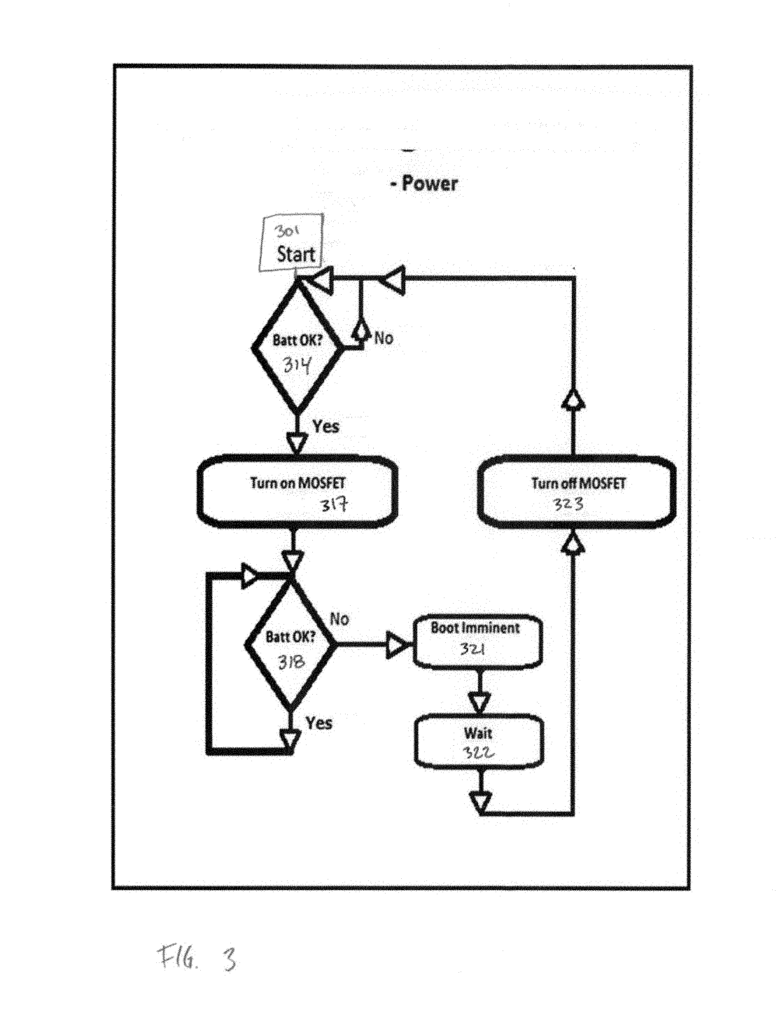

As shown in FIGS. 1-6, the power lifeguard system of the invention provides an uninterruptible power source that monitors power flow and communicates power outages and anomalies to computer systems, such as single board computers (SBCs), for example.

FIG. 1 shows a detailed block diagram of one example system 100 of the invention. The system 100 includes a power lifeguard 101 connected to a single board computer (SBC) 190. Many SBCs 190 include an operating system, which can become corrupt if the SBC 190 is not shut down properly, such as in the case of power to the SBC 190 being removed abruptly. Likewise, most SBCs do not have traditional BIOS firmware used to perform hardware initialization during the booting process, so boot options are limited. Many SBCs will boot when power is turned on. If an SBC is shut down or crashes, it will not reboot until power is turned off and back on. The power lifeguard of the invention provides an intelligent monitor to ensure critical systems remain operational by turning power off/on when appropriate.

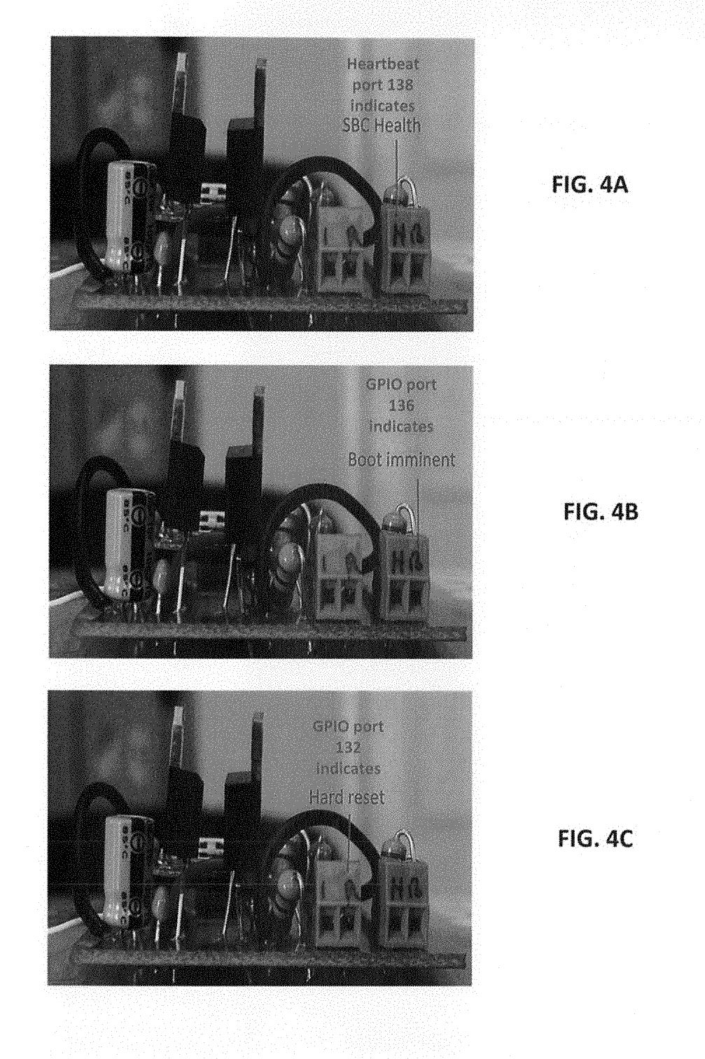

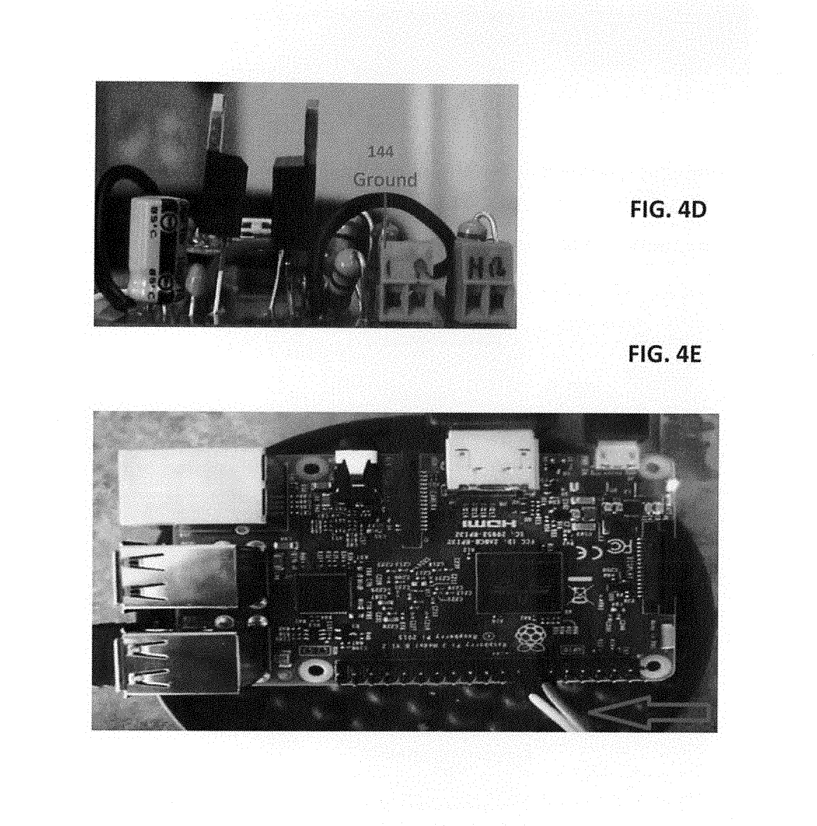

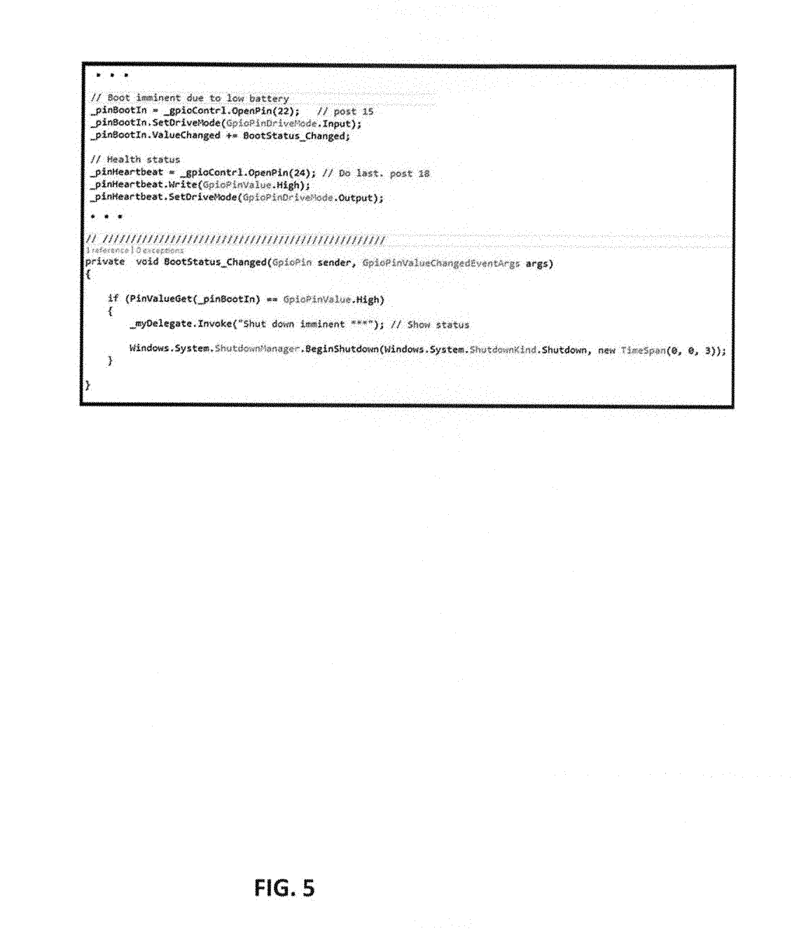

The controller 107 of the power lifeguard 101 does not require an operating system but does have the ability to run simple programs. Turning a controller on and off will not corrupt the controller. Many SBCs will start up when power is turned on without any additional action. The controller 107 manages the more complex SBC 190. If the SBC 190 crashes or is turned off, the controller 107 of the power lifeguard 101 recognizes the outage and turns the SBC 190 back on by cycling power to the SBC 190. The power lifeguard 101 connects to the SBC 190 via digital GPIO ports as shown in FIG. 4E. The SBC can run a few lines of code to communicate with the power lifeguard. FIG. 5 shows an example communication code installed on an SBC 190 to communicate with the power lifeguard 101.

In some example systems of the invention, communication between the power lifeguard 101 and the computers (PCs, SBCs, and the like) is conducted via GPIO high/low signals. Table 1 below shows an example power lifeguard 101 with GPIO ports listed based on their connections and their function.

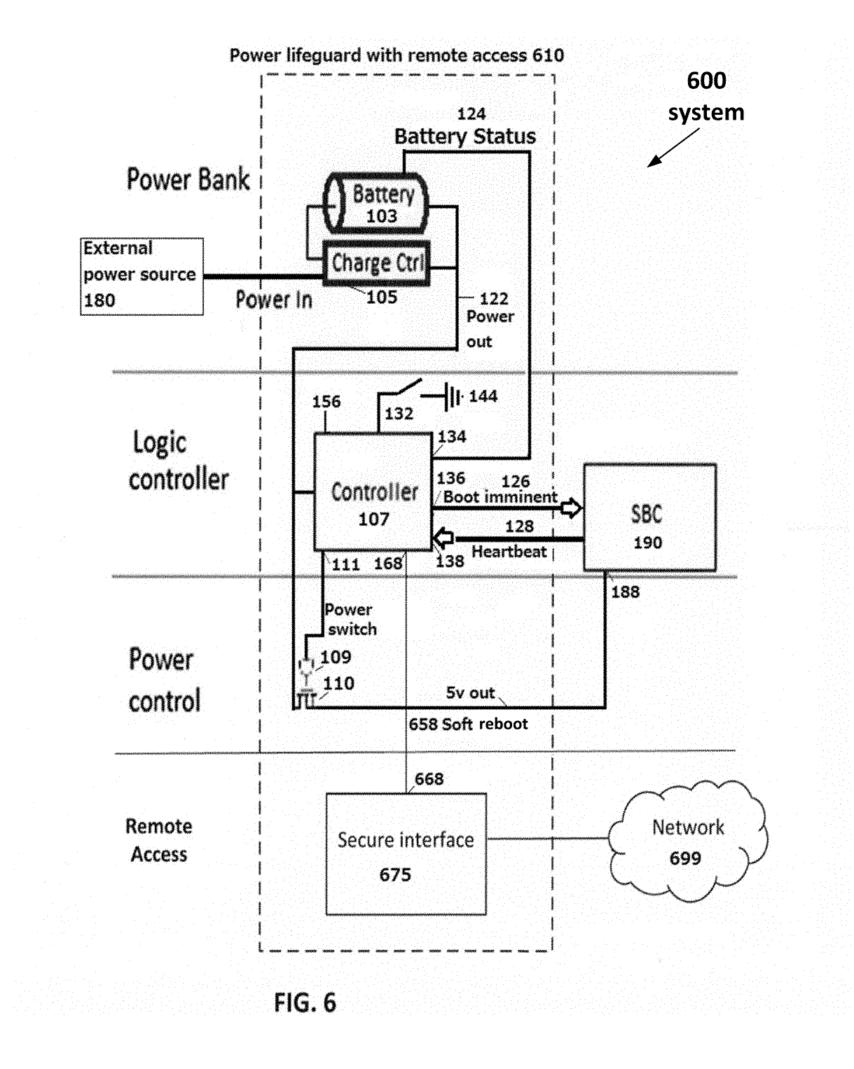

TABLE 1

| GPIO | GPIO Port Ref. | | |
|---|---|---|---|
| Input/Output | Numeral in FIGS. | Direction | Description |
| GPIO expansion port | 156 | Can be custom | Signal high for power is on. This expansion port can be used |
| | | configured | to send/receive a signal to an SBC GPIO port, or to/from other |
| | | | external devices. In one example power lifeguard, the expansion |
| | | | port is used to communicate power-on status of the power lifeguard |
| | | | to an SBC. |
| Reboot imminent | 136 | Power lifeguard | Signal high to indicate a reboot will occur within the configured time |
| | | to SBC | |
| Heartbeat | 138 | SBC to power | High signal from the SBC indicating the computer is operational and ready. |
| | | lifeguard | Also used for logic gates. |
| Force soft reboot | 168 | Switch on power | The switch 168 in FIG. 1 and from secure interface in FIG. 6 provides a |
| | | lifeguard (FIG. 1) | signal to indicate a reboot of the SBC is requested. When the port is high, |
| | | and from network | the controller initiates a controlled shutdown process. |
| | | interface to power | |
| | | lifeguard (FIG. 6) | |
| Force hard reboot | 132 | Switch on power | The switch initiates a reset (hard boot) that resets the power lifeguard |
| | | lifeguard | controller by cycling power off and then back on, which cycles power to |
| | | | the SBC. |
| Ground | 144 | Non-directional | Provides electronic ground for hard reset and other signals. |

Returning to FIG. 1, the system 100 receives power from external power source 180, which supplies a DC voltage, such as a voltage ranging form 7.4 to 8.4 volts, for example. The system 100 can receive the power-in from an external DC voltage power source or can ultimately receive the power-in from an AC voltage power source equipped with a rectifier circuit that converts AC current to DC current.

Similarly, battery pack 103 also supplies DC voltage in a similar voltage range. Further, capacitors with directional power flow can also be used to supply the needed voltage. When the SBC 190 requires higher current, additional batteries can be added to the battery pack 103 in a parallel configuration. Battery life will be determined based on the current draw of the SBC 190. The external power source 180 provides power out 122 to charge controller 105. Charge controller 105 limits the rate at which current is added to or drawn from the battery pack 103. Charge controller 105 prevents overcharging and from overvoltage conditions, which can reduce battery performance or battery lifespan. Charge controller 105 automatically switches the source of power (power out 122) to the SBC 190 from external power source 180 to battery power when the power level of the external power source 180 falls below a pre-established level. In this fashion, the charge controller 105 provides the power lifeguard 101 with continuous power.

The system 100 also uses a battery status connection 124 from battery 103 to controller 107 that indicates the charge level of the battery 103. Users can configure the controller 107 with pre-determined monitoring rules using hardware and/or software and/or firmware on controller 107. A program runs on the controller 107 to enforce the pre-determined monitoring rules.

For example, the controller 107 senses the voltage level of the battery 103 through battery status connection 124 that provides a signal to indicate battery charge level. The controller 107 will not power-up the SBC 190 unless the battery 103 is at a level capable of sustaining operation of SBC 190 in the event of an outage of external power source 180. If the controller 107 senses an acceptable voltage level (via status connection 124), battery power can be provided to the SBC 190 via power switch 109. To power on the SBC 190, the controller 107 can set a general-purpose input/output (GPIO) digital pin high at power switch connection 111 to provide power (via a MOSFET, for example) to the SBC 190. After power is provided at power switch connection 111 to MOSFET switch 109, the DC voltage can be regulated to the operational voltage of the SBC 190. For example, in one example configuration of the invention, once the DC voltage passes through the MOSFET power-on switch 109, the voltage is reduced to 5 volts for operation of the SBC 190. If the SBC requires a different operational power voltage, the controller 107 and power-on switch 109 can be configured to supply the required operational voltage.

Additionally, when the controller 107 senses the voltage level of the battery 103 through battery status connection 124 has dropped below a pre-determined level, or when the controller 107 is reset, the controller 107 initiates a boot imminent event notification 126 to the SBC 190. In initiating the boot imminent event notification 126, the controller 107 sends a general-purpose input/output (GPIO) control signal to inform the SBC 190 that power will be shut off and back on (i.e., to boot the SBC 190). After the system 100 sends the boot imminent event notification 126 (for example, by setting a digital GPIO pin high), the controller 107 waits a pre-determined amount of time to give the SBC 190 ample time to cleanly shut down. After the pre-determined amount of time, power is shut off to the SBC 190.

As shown further in FIGS. 1, 2, and 4A-4E, in operation, the SBC 190 can include software and/or hardware and/or firmware to provide a heartbeat signal 128 that provides information to the controller 107 that the SBC 190 is operational. In block 201, the controller 107 of the power lifeguard 101 starts and looks to see if the heartbeat signal 128 GPIO value at port 138 is high. If, in block 202, the heartbeat signal 128 is low, the controller will return to block 201 and wait for the heartbeat signal 128. If, in block 202, the heartbeat signal 128 is high, the process continues to block 205 where the controller monitors the heartbeat signal 128. As the controller 107 monitors the heartbeat signal 128, while the signal 128 remains high (that is, there is NO transition from high to low), the controller continues to monitor the heartbeat signal 128.

When the heartbeat GPIO pin 138 goes from high to low (that is, YES, there is a transition from high to low), the process continues to block 208 where a timer is set in case the loss of the heartbeat signal 128 (that is, a drop in voltage) is an anomaly. In some example systems of the invention, the timer value is fixed, while in other example systems of the invention, the timer value can be changed and set to different amounts of time using software and/or hardware and/or firmware.

In block 209, the controller 107 checks to see if the heartbeat signal 128 changes back from low to high during the time period (duration) that the timer is counting. If the heartbeat signal 128 changes back from low to high during the time period (that is, YES, the signal transitioned back to high), it is likely that the signal loss was insignificant, and in block 215, the controller 107 turns the timer off, and the process returns to block 205 where the controller monitors the heartbeat signal 128. If, in block 209, the heartbeat signal 128 does not return to high during the time period (that is, NO, the signal did not transition back to high), it is likely that the signal loss was significant, and the process continues to block 211.

In block 211, the controller 107 determines if the duration of time for which the time is set has expired. If the timer duration has not expired, the process returns to block 209, and the controller 107 again checks to see if the heartbeat signal 128 changes back from low to high during the time period (duration) that the timer is counting. If, in block 211, the heartbeat signal 128 remains low when the timer expires, the process continues to block 213, and indicates to the controller 107 that SBC heartbeat failed. That is, the heartbeat signal 128 was initiated by the SBC 190, and the heartbeat signal 128 coming in to GPIO heartbeat port 138 later went from high to low, and the heartbeat signal 128 did not reappear for a given amount of time. The controller 107 then issues the boot imminent signal 126 from the boot imminent port 136 on the controller 107 to the SBC 190 indicating that the controller 107 will initiate a normal power down/power up event to reboot the SBC 190.

As shown in FIGS. 1, 3, and 4A-4E, in operation, the controller 107 manages power to the SBC 190 via a GPIO port 111 to turn on and off a MOSFET 109 and voltage regulator 110. At the start of operation, in block 301, the controller 107 checks the battery charge level via battery status signal 124 at GPIO port 134. If the batteries are not properly charged in block 314 (that is NO, the batteries are not OK), the process returns to the start 301, and the controller 107 waits for the batteries to charge enough (to an acceptable pre-determined voltage level) to sustain the SBC 190 in the event of main-power loss.

When the batteries reach a sustainable level in block 314 (that is YES, the batteries are OK), the controller 107 sets a GPIO port 111 high to turn on a MOSFET power switch 109 and voltage regulator 110 in block 317. The MOSFET power switch 109 and voltage regulator 110 provide power to the SBC 190 at input power port 188.

As operations continue, the controller 107 continually checks the status of the batteries 103 in block 318. As long as the status of the batteries 103 remains OK, operations continue. If the battery level drops to an unsafe pre-determined level (that is, NO, the batteries 103 are not OK in block 318), the controller 107 prepares to initiate a boot imminent process in block 321. The controller 107 sets GPIO port 136 high to alert the SBC 190 that power will be shut off. After setting the GPIO boot imminent port 136 high, the controller 107 waits a pre-determined amount of time in block 322 to give the SBC 190 an opportunity to shut down in a controlled manner. The wait time can be a fixed amount of time in some example systems of the invention and can be configured for different amounts of time in other example systems of the invention.

After the wait-period, the controller 107 sets the GPIO port 111 controlling the MOSFET low in block 323, which turns off power to the SBC 190. After turning off power to the SBC 190, the process returns to the start block 301. Turning off power to the SBC 190 also resets the heartbeat as described above. The SBC 190 restarts when power is turned off and then back on as outlined above.

In the event of a lockup, a user can perform a hard reset of the power lifeguard 101 by grounding the reset port 132 of the controller 107 using a switch or other control mechanism to reset the entire system. See FIGS. 1 and 4C. The hard reset is a failsafe option that can be used if the system appears to be locked up.

In one example system of the invention, the pre-determined times described above can be adjusted using DIP-switches to adjust startup, heartbeat, reboot, and power-off timers. For example, in order to account for short power outages and system reboot times, timespans are configurable via dip-switches, an interactive touch screen, values provided by a web service, and other hardware and/or software selection devices. Examples of the configurable timespans and descriptions are shown below in Table 2.

With a delayed timespan setting, if the heartbeat goes off and on for a short time, a boot will not occur. Also, the pre-determined time between a boot imminent signal and a shutdown can also be configured using DIP-switches. Additionally, a display screen can be incorporated to show basic functional values including battery charge, heartbeat status, boot imminent, and other timer settings.

Table 2 below shows example time settings for a number of the pre-determined time measures using DIP switch settings (to implement the different timespans).

TABLE 2

| DIP switch | Timespan |
|---|---|
| HB Power bump | +3 sec |
| HB Power bump | +10 sec |
| Boot time | +30 sec |
| Boot time | +60 sec |
| Boot time | +2 min |
| Boot time | +5 min |

In one example system of the invention, the controller can communicate status, timer configurations, and other settings using a network connection to the Internet or other computer network. The invention can be configured to accept (remote) boot commands via the network from remote users.

For example, there may be times when a computer (PC, SBC, and other computing devices) becomes non-responsive. As shown in FIG. 6, using a secure interface 675 that includes Web Service access, administrators can determine if specific power lifeguards 601 should initiate a reboot when the SBC 690 becomes non-responsive. If Internet or other network 699 access is available, the power lifeguard system 600 can periodically check a web service for remote reboot instructions. When a reboot command is received by the secure interface 675, the power lifeguard system 600 will notify the SBC 690 of an imminent shutdown and then follow the process described above as if power had been lost.

The power lifeguard systems and methods of the invention provide a smarter version of a UPS to ensure computers, and in particular SBCs, remain operational in the event of a power outage or other power anomaly. The invention provides a small system package that can be used in many applications and environments where traditional power control systems could not be sited, including single board computers.

What is claimed is:

1. A power management system comprising:
a battery backup; and
a computer controller system that monitors operational status of the battery back up and monitors operational status of a computer system to which the power management system is operatively connected.

2. A power management system of claim 1, wherein the power management system is a single printed circuit board (PCB) device.

3. A power management system of claim 1, wherein the computer system is a single board computer (SBC).

4. A power management system of claim 3, wherein the single board computer (SBC) operates on 12 or fewer watts of power.

5. A power management system of claim 1, wherein the operational status of the computer system includes at least one of a power outage and a loss of a communication signal from the computer system to the power management system.

6. A power management system of claim 1, wherein the computer controller system includes a first general purpose input/output (GPIO) port that receives a battery status signal to monitor the operational status of the battery back up and a second general purpose input/output GPIO port that receives a heartbeat signal to monitor the operational status of the computer system to which the power management system is operatively connected.

7. A power management system of claim 1 further comprising:
a charge controller operatively connected to the battery back up that limits the rate at which current is added to or drawn from the battery back up.

8. A power management system of claim 1 further comprises:
a power switch controlled by the computer controller system that provides power to the computer system.

9. A power management system of claim 1, wherein the computer system includes communication code to communicate with the power management system.

10. A power management system of claim 1 further comprising:
a remote interface that initiates the turning off the uninterrupted backup source of power to the computer system via a computer network.

11. A method of managing power to a computer system comprising:
sensing an unresponsive computer system with a computer controller system;
providing an uninterrupted backup source of power to the computer system;
warning the computer system of an imminent booting of the computer system; and
turning off the uninterrupted backup source of power to the computer system.

12. A method of managing power to a computer system of claim 11, wherein sensing an unresponsive computer system includes identifying a loss of power to the computer system.

13. A method of managing power to a computer system of claim 12, wherein turning off the uninterrupted backup source of power to the computer system includes:
confirming the uninterrupted backup source of power to the computer system has dropped below a predetermined level;
setting a general purpose input/output (GPIO) port to communicate with the computer system that a boot event is imminent.
waiting a predetermined period of time to provide the computer system an opportunity to shut down in a controlled manner; and
setting a general purpose input/output (GPIO) port to operate a switch to remove power from the computer system.

14. A method of managing power to a computer system of claim 13, wherein turning off the uninterrupted backup source of power to the computer system includes:
receiving a soft reboot signal from a remote interface via a computer network.

15. A method of managing power to a computer system of claim 11, wherein sensing an unresponsive computer system includes identifying a loss of a heartbeat signal from the computer system to the computer controller system.

16. A method of managing power to a computer system of claim 15, wherein turning off the uninterrupted backup source of power to the computer system includes:
setting a timer to a predetermined period of time;
monitoring the heartbeat signal from the computer system at a general purpose input/output port of the computer controller system during the predetermined period of time;
confirming that the loss of the heartbeat signal from the computer system at the general purpose input/output port of the computer controller system has not recovered during the predetermined period of time;
setting a general purpose input/output (GPIO) port to communicate with the computer system that a boot event is imminent.
waiting a predetermined period of time to provide the computer system an opportunity to shut down in a controlled manner; and
setting a general purpose input/output (GPIO) port to operate a switch to remove power from the computer system.

17. A method of managing power to a computer system of claim 16, wherein turning off the uninterrupted backup source of power to the computer system includes:
receiving a soft reboot signal from a remote interface via a computer network to operate the switch to remove power from the computer system.

18. A method of managing power to a computer system of claim 11 further comprising:
restoring power to the computer system to initiate a boot sequence of the computer system.

19. A method of managing power to a computer system of claim 18, wherein restoring power to the computer system to initiate a boot sequence of the computer system includes:
receiving a battery status signal at a general purpose input/output (GPIO) port of the computer controller system;
determining a voltage level of the uninterrupted backup source of power to the computer system is within a predetermined voltage range based upon the received battery status signal; and
setting a general purpose input/output (GPIO) port of the computer controller system to operate a switch to restore power to the computer system.
